(19) United States
(12) Patent Application Publication
(10) Pub. No.: US 2018/0173946 A1
(43) Pub. Date: Jun. 21, 2018

(54) LEARNING DEVICE, PAPER SHEET IDENTIFICATION DEVICE, AND PAPER SHEET IDENTIFICATION METHOD

(71) Applicants: Kabushiki Kaisha Toshiba, Minato-ku (JP); Toshiba Infrastructure Systems & Solutions Corporation, Kawasaki-shi (JP)

(72) Inventors: Hiroshi MATSUKI, Yokohama (JP); Naotake Natori, Tachikawa (JP); Mitsutake Hasebe, Kawasaki (JP)

(73) Assignees: Kabushiki Kaisha Toshiba, Minato-ku (JP); Toshiba Infrastructure Systems & Solutions Corporation, Kawasaki-shi (JP)

(21) Appl. No.: 15/839,070

(22) Filed: Dec. 12, 2017

(30) Foreign Application Priority Data
Dec. 19, 2016 (JP) 2016-245402

(51) Int. Cl. G06K 9/00; G06K 9/32; G07D 11/00; G06N 3/02

(52) U.S. Cl. CPC G06K 9/00456; G06K 9/3233; G06N 3/02; G07D 11/0021; G07D 11/0036

(57) ABSTRACT

A learning device according to an embodiment includes an acquirer, an extractor, a plurality of processors, and an identifier. The acquirer is configured to acquire a paper sheet image which is a captured image of a paper sheet. The extractor is configured to extract a plurality of primary feature images having different objects to be recognized from the paper sheet image acquired by the acquirer. The plurality of processors are configured to perform respective convolution and pooling processes on the plurality of primary feature images extracted by the extractor to generate a plurality of secondary feature images having different objects to be recognized. The identifier is configured to sequentially update and learn a parameter set for identifying a sheet type of the paper sheet on the basis of a result of a combination process on each of the plurality of secondary feature images generated by the plurality of processors.

### CROSS-REFERENCE TO RELATED APPLICATIONS

This application is based upon and claims the benefit of priority from Japanese Patent Application No. 2016-245402, filed Dec. 19, 2016; the entire contents of which are incorporated herein by reference.

### FIELD

Embodiments described herein relate generally to a learning device, a paper sheet identification device, and a paper sheet identification method.

### BACKGROUND

A conventional paper sheet processing apparatus reads an image of a paper sheet and detects a representative pattern on the paper sheet in the read image to identify the sheet type of the paper sheet. However, there are some cases where the conventional paper sheet processing apparatus takes some time to perform a sheet type identification process since a large number of calculations need to be performed to accurately specify the position at which the representative pattern of the paper sheet is present.

A deep learning technique which is called a convolutional neural network (CNN) is attracting attention in the field of image recognition processing. Although a CNN has an advantage of having high image recognition accuracy, it tends to increase the amount of calculation and the processing time. Particularly, when a CNN is applied to a plurality of images, the calculation time increases in proportion to the number of images. Therefore, it is not easy to apply a CNN to paper sheet processing apparatuses in which high speed processing is required.

### BRIEF DESCRIPTION OF THE DRAWINGS

FIG. 1 is a cross-sectional view of a paper sheet processing apparatus according to an embodiment.

FIG. 2 is a block diagram showing a control configuration of an inspection device according to the embodiment.

FIG. 3 is a diagram showing first to third feature images in a bill image according to the embodiment.

FIG. 4 is a flowchart showing an example of a procedure in a learning stage in the inspection device according to the embodiment.

FIG. 5 is a diagram showing a convolution process of a first convolution processor according to the embodiment.

FIG. 6 is a diagram showing a pooling process in a first pooling processor according to the embodiment.

FIG. 7 is a diagram showing a sheet type identification process based on the first to third feature images in a sheet type identifier according to the embodiment.

FIG. 8 is a flowchart showing an example of a procedure in an operation stage in the inspection device according to the embodiment.

### DETAILED DESCRIPTION

A learning device according to an embodiment includes an acquirer, an extractor, a plurality of processors, and an identifier. The acquirer is configured to acquire a paper sheet image which is a captured image of a paper sheet. The extractor is configured to extract a plurality of primary feature images having different objects to be recognized from the paper sheet image acquired by the acquirer. The plurality of processors are configured to perform respective convolution and pooling processes on the plurality of primary feature images extracted by the extractor to generate a plurality of secondary feature images having different objects to be recognized. The identifier is configured to sequentially update and learn a parameter set for identifying a sheet type of the paper sheet on the basis of a result of a combination process on each of the plurality of secondary feature images generated by the plurality of processors.

Hereinafter, a learning device, a paper sheet identification device, and a paper sheet identification method according to an embodiment will be described with reference to the drawings.

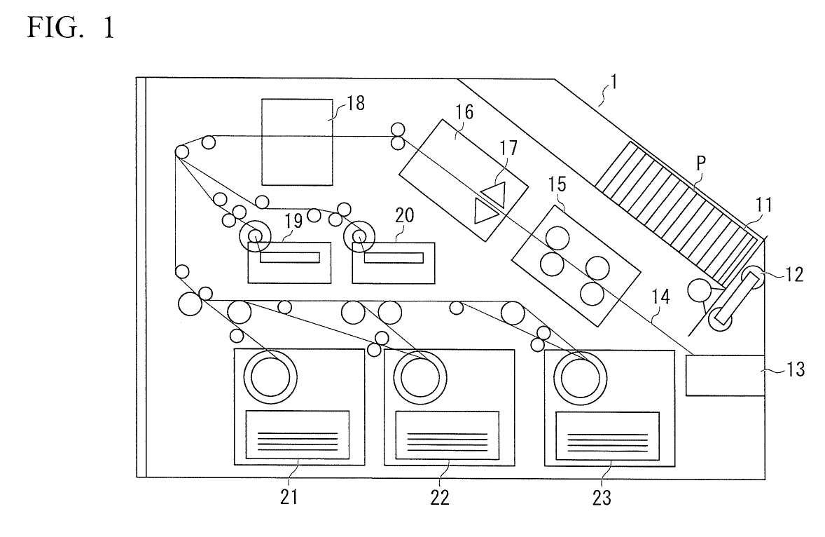

FIG. 1 is a cross-sectional view of a paper sheet processing apparatus 1 according to the present embodiment. The paper sheet processing apparatus 1 performs a procedure for sorting paper sheets P. Hereinafter, a description will be given with reference to a bill as an example of the paper sheet P.

As shown in FIG. 1, the paper sheet processing apparatus 1 includes, for example, a supplier 11, rollers 12, a foreign matter collector 13, a conveyance path 14, a conveyer 15, an inspection device 16 (i.e., a learning device or a paper sheet identification device), a line sensor 17, a barcode reader 18, rejecters 19 and 20, and cassettes 21 to 23. A plurality of bills P are placed in the supplier 11. The rollers 12 deliver the bills P one by one from the supplier 11 to the conveyance path 14. The bills P delivered by the rollers 12 are conveyed along the conveyance path 14. A plurality of pairs of endless conveyance belts (not shown) are provided along the conveyance path 14 so as to sandwich the conveyance path 14 therebetween. The bills P delivered by the rollers 12 are nipped and conveyed by the conveyance belts.

The conveyance path 14 extends obliquely toward the inspection device 16 from a position at which the bills P exit the rollers 12. This allows foreign matter such as a clip, a coin, a pin, or the like to drop to a lowermost portion of the conveyance path 14 by gravity when the foreign matter is delivered from the supplier 11 together with the bills P to the conveyance path 14. As a result, it is possible to prevent foreign matter from entering the inspection device 16 and to prevent damage to the inspection device 16 due to foreign matter.

The foreign matter collector 13 is disposed at the lowermost portion of the conveyance path 14. The foreign matter collector 13 includes, for example, a collection box that can be withdrawn from the body of the apparatus. Foreign matter dropping along the conveyance path 14 drops to and is collected in the foreign matter collector 13.

The conveyer 15 adjusts the conveyance speed of the bills P such that the bills P are spaced at predetermined intervals, and conveys the bills P to the inspection device 16. The inspection device 16 reads an image of each of the bills P to detect the sheet type of the bills P, the front and back orientation of the bills P, and abnormalities (such as tears, folds, or dirt) of the bill P. The inspection device 16 includes therein the line sensor 17 including a light emitting element such as a light emitting diode (LED) and a photoelectric conversion element such as a charge coupled device (CCD) or a complementary metal oxide semiconductor (CMOS). A monitoring terminal (not shown), which allows operators to view an image captured by the line sensor 17 and to input various information, may be connected to the line sensor 17.

When an abnormality of a bill P is detected, the paper sheet processing apparatus 1 conveys the bill P along the conveyance path 14 and sorts the bill P and stacks it in the rejecter 19 or 20 according to the type of abnormality. On the other hand, if no abnormalities of the bill P are detected, the paper sheet processing apparatus 1 passes the bill P through the barcode reader 18 and then sorts the bill P and stacks it in the cassettes 21 to 23 according to the sheet type of the bill P. The above is the bill sorting procedure.

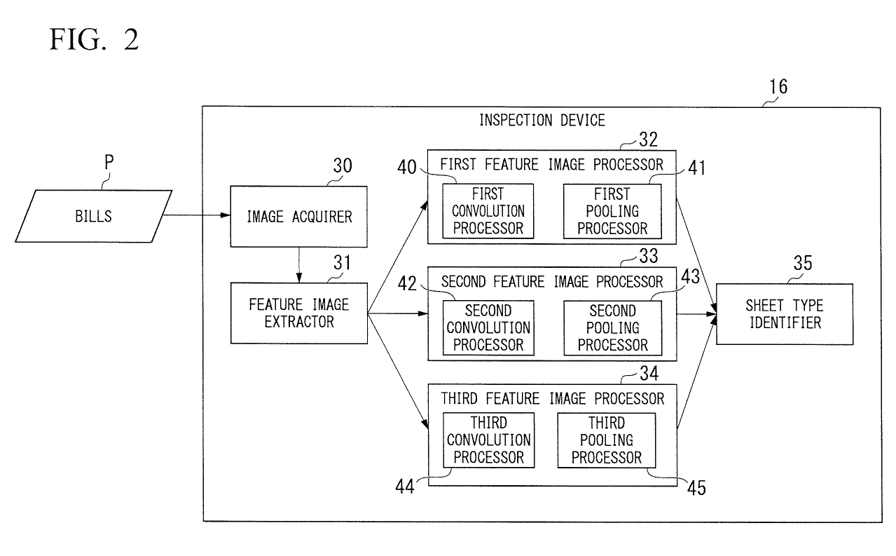

FIG. 2 is a block diagram showing a control configuration of the inspection device 16 according to the present embodiment. FIG. 2 shows a control configuration of the inspection device 16 for identifying the sheet type of the bill P. The inspection device 16 includes, for example, an image acquirer 30 (acquirer), a feature image extractor 31 (extractor), a first feature image processor 32 (processor), a second feature image processor 33 (processor), a third feature image processor 34 (processor), and a sheet type identifier 35 (identifier).

The image acquirer 30 captures an image of the bill P passing through the inspection device 16 and acquires the captured image of the bill P. The image acquirer 30 inputs the acquired captured image into the feature image extractor 31. The image acquirer 30 includes, for example, a line sensor 17.

The feature image extractor 31 extracts a plurality of small-scale characteristic images (primary feature images) having different objects to be recognized, suitable for classifying the sheet type of the bill P, from the captured image input from the image acquirer 30. For example, the feature image extractor 31 extracts a plurality of small-scale characteristic images from a bill image, which has been obtained by removing a background image or the like from the captured image, on the basis of pre-specified coordinate information.

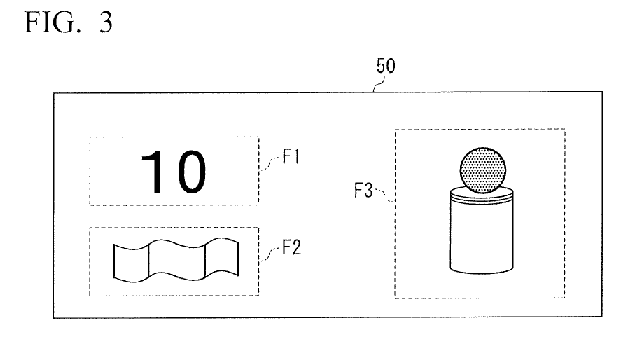

FIG. 3 is a diagram showing a first feature image F1, a second feature image F2, and a third feature image F3 in the bill image 50 according to the present embodiment. As shown in FIG. 3, the bill image 50 includes, as a plurality of small-scale characteristic images suitable for classifying the sheet type of the bill P, the first feature image F1 which is an image of a region where a denomination numeral is printed, the second feature image F2 which is an image of a region where a symbol is printed, and the third feature image F3 which is an image of a region where a portrait image is printed. Images in regions other than the first feature image F1, the second feature image F2, and the third feature image F3 may also be used as the feature images. The following description will be given with reference to an example in which the feature image extractor 31 is configured to extract the first feature image F1, the second feature image F2, and the third feature image F3.

The feature image extractor 31 inputs the first feature image F1, the second feature image F2, and the third feature image F3 extracted from the bill image 50 into the first feature image processor 32, the second feature image processor 33, and the third feature image processor 34, respectively. In the case where the feature image extractor 31 extracts images of other regions as feature images in addition to the first feature image F1, the second feature image F2, and the third feature image F3, the feature image extractor 31 may input the images of the other regions into additional feature image processors (such as a fourth feature image processor and a fifth feature image processor).

The first feature image processor 32 includes, for example, a first convolution processor 40 and a first pooling processor 41. The first convolution processor 40 performs a convolution process on the first feature image F1. The first pooling processor 41 performs a pooling process on the convoluted image acquired through the processing of the first convolution processor 40. In the first feature image processor 32, the convolution process and the pooling process are repeated a predetermined number of times. The first feature image processor 32 inputs the pooled image (secondary feature image) into the sheet type identifier 35.

The second feature image processor 33 includes, for example, a second convolution processor 42 and a second pooling processor 43. The second convolution processor 42 performs a convolution process on the second feature image F2. The second pooling processor 43 performs a pooling process on the convoluted image acquired through the processing of the second convolution processor 42. In the second feature image processor 33, the convolution process and the pooling process are repeated a predetermined number of times. The second feature image processor 33 inputs the pooled image (secondary feature image) into the sheet type identifier 35.

The third feature image processor 34 includes, for example, a third convolution processor 44 and a third pooling processor 45. The third convolution processor 44 performs a convolution process on the third feature image F3. The third pooling processor 45 performs a pooling process on the convoluted image acquired through the processing of the third convolution processor 44. In the third feature image processor 34, the convolution process and the pooling process are repeated a predetermined number of times. The third feature image processor 34 inputs the pooled image (secondary feature image) into the sheet type identifier 35.

That is, the plurality of image processors (i.e., the first feature image processor 32, the second feature image processor 33, and the third feature image processor 34) generate pooled images having different objects to be recognized by performing respective convolution and pooling processes on the plurality of feature images extracted by the feature image extractor 31.

The sheet type identifier 35 performs a full combination process (a combination process) on each of the pooled image input from the first feature image processor 32, the pooled image input from the second feature image processor 33, and the pooled image input from the third feature image processor 34 and sequentially updates and learns a parameter set for identifying the sheet type of the bill P or identifies the sheet type of the bill P on the basis of the result of the full combination process. The sheet type identifier 35 changes the pooled images, which are to be learned or to be subjected to the full combination process, according to the time. For example, a network in which activation functions such as a sigmoid function and a ReLu function are combined in a plurality of layers is formed in the sheet type identifier 35.

A part or all of the functional units, which are the feature image extractor 31, the first feature image processor 32, the second feature image processor 33, the third feature image processor 34, and the sheet type identifier 35, are realized by a processor such as a CPU executing programs stored in a program memory. A part or all of these functional units may also be realized by hardware such as a large scale integration (LSI) and an application specific integrated circuit (ASIC) which has the same functionality as the processor executing the programs.

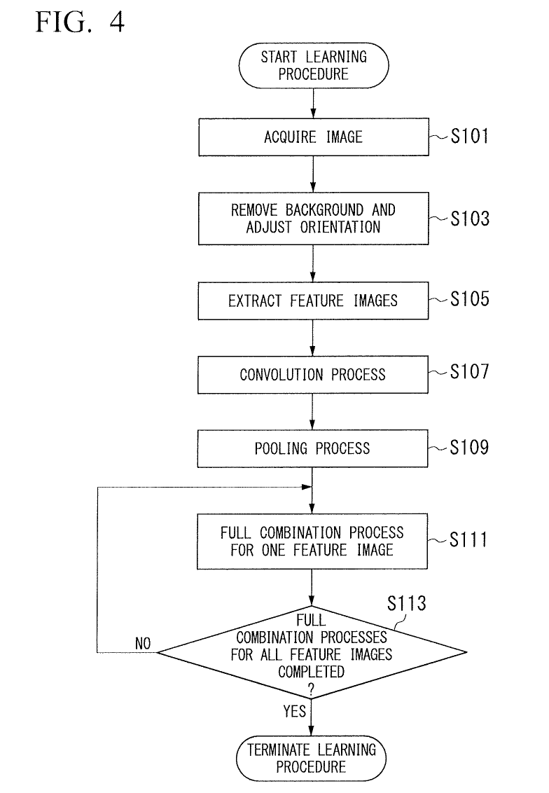

The operation of the inspection device 16 of the present embodiment will now be described. The operation of the inspection device 16 is roughly divided into a learning stage in which advanced preparation for sheet type identification of bills is performed and an operation stage in which sheet type identification of bills is performed. First, a procedure in the learning stage will be described. FIG. 4 is a flowchart showing an example of a sequence of the procedure in the learning stage of the inspection device 16 according to the present embodiment. The inspection device 16 in the learning stage is referred to as a “learning device”, and the inspection device 16 in the operation stage is referred to as a “paper sheet identification device”.

First, the image acquirer 30 captures an image of a bill P passing through the inspection device 16 (learning device) and acquires the captured image (a paper sheet image) (step S101). The image acquirer 30 inputs the acquired captured image into the feature image extractor 31.

Then, the feature image extractor 31 extracts a region where the image of the bill P has been captured (i.e., a bill image) from the entire captured image input from the image acquirer 30 and adjusts the orientation of the bill image in a predetermined direction (Step S103). For example, assuming that the color of the background captured in the above image capturing process is a single color from black or white, the feature image extractor 31 may extract a region whose brightness is different from the background color as the region where the image of the bill P has been captured. The feature image extractor 31 may detect edges of the bill P from the captured image and extract the region where the image of the bill P has been captured. An arbitrary method may be used for the background removal process of the present embodiment.

Further, for example, the feature image extractor 31 may perform an affine transformation or the like on the vertices of the bill image obtained by the above background removal process and may then adjust the orientation of the bill image in a predetermined direction by adjusting the positions of the vertices as desired (for example, setting the coordinates of vertices at both ends of each longer side of the bill P to be the same in the direction of the shorter sides when aligning the longer sides of the bill P horizontally). An arbitrary method may be used for orientation adjustment in the present embodiment.

Then, the feature image extractor 31 extracts, from the bill image whose orientation has been adjusted in a predetermined direction, a plurality of small-scale characteristic images suitable for classifying the sheet type of the bill P on the basis of pre-specified coordinate information (step S105). For example, as shown in FIG. 3, the feature image extractor 31 extracts, from the bill image 50, the first feature image F1 which is an image of a region where a denomination numeral is printed, the second feature image F2 which is an image of a region where a symbol is printed, and the third feature image F3 which is an image of a region where a portrait image is printed. The feature image extractor 31 inputs the first feature image F1, the second feature image F2, and the third feature image F3 into the first feature image processor 32, the second feature image processor 33, and the third feature image processor 34, respectively.

Then, the first convolution processor 40 of the first feature image processor 32 performs a convolution process on the first feature image F1 input from the feature image extractor 31, the second convolution processor 42 of the second feature image processor 33 performs a convolution process on the second feature image F2, and the third convolution processor 44 of the third feature image processor 34 performs a convolution process on the third feature image F3 (Step S107). The convolution process of the first convolution processor 40, the second convolution processor 42, and the third convolution processor 44 are the same except that the images to be processed are different. In the following, the convolution process of the first convolution processor 40 will be described as an example.

The first convolution processor 40 performs a convolution calculation using an arbitrary-size coefficient matrix for convolution. For example, the first convolution processor 40 extracts a small image having the same size as the coefficient matrix from the first feature image F1 and acquires one pixel by performing a convolution calculation using the small image and the coefficient matrix. The first convolution processor 40 acquires a plurality of images by repeatedly performing the convolution calculation while changing (sliding) the small image extracted from the first feature image F1. A set of the plurality of acquired images constitutes a convoluted image.

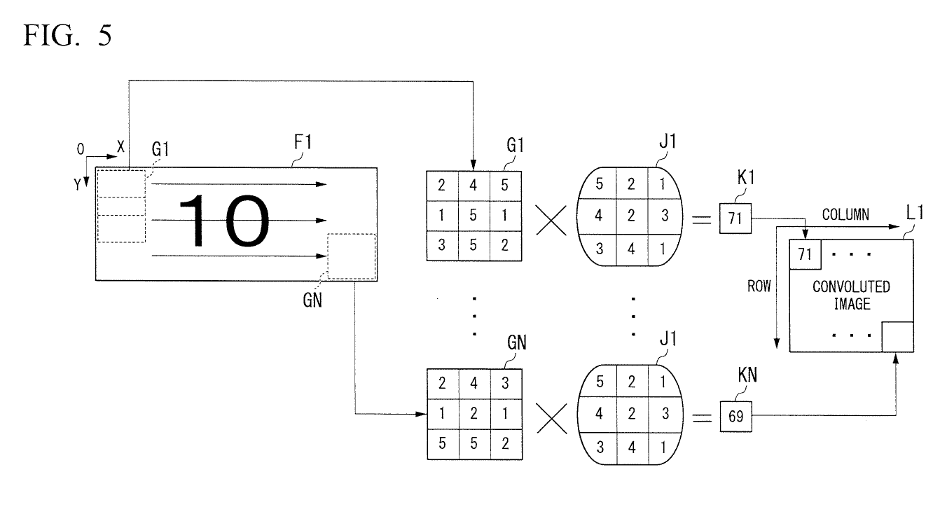

FIG. 5 is a diagram showing a convolution process of the first convolution processor 40 according to the present embodiment. As shown in FIG. 5, for example, the first convolution processor 40 extracts a first small image G1 of 3×3 pixels located at a point 0 (at the upper left corner of the first feature image F1) from the first feature image F1 and performs a convolution calculation (2×5+4×2+5×1+1+5×2+1+3×3+5×4+2×1=71) using the first small image G1 and a 3×3 coefficient matrix J1 to obtain a first calculated value K1. This first calculated value K1 constitutes an image of one pixel (in the first row and first column) of the convoluted image L1.

Then, the first convolution processor 40 slides the position of extraction of the small image from the first feature image H by one pixel in the X direction and performs a similar convolution process. After the extraction of small images in the X direction is completed, the first convolution processor 40 slides the small image extraction position by one pixel in the Y direction and performs a similar convolution process. In this manner, while moving the small image extraction position in the X direction and the Y direction, the first convolution processor 40 repeats the convolution process until the final position in the first feature image F1 (for example, the lower right corner of the first feature image F1) is reached. Although the extraction position is moved from the upper left corner to the lower right corner of the first feature image F1 in the present embodiment, the order of movement is not limited to this, provided that it can move throughout the entire region of the first feature image F1. A convoluted image L1 is acquired through this convolution process.

Then, the first pooling processor 41 performs a pooling process on the convoluted image input from the first convolution processor 40, the second pooling processor 43 performs a pooling process on the convoluted image input from the second convolution processor 42, and the third pooling processor 45 performs a pooling process on the convoluted image input from the third convolution processor 44 (step S109). The pooling processes of the first pooling processor 41, the second pooling processor 43, and the third pooling processor 45 are the same except that the images to be processed are different. In the following, the pooling process of the first pooling processor 41 will be described as an example.

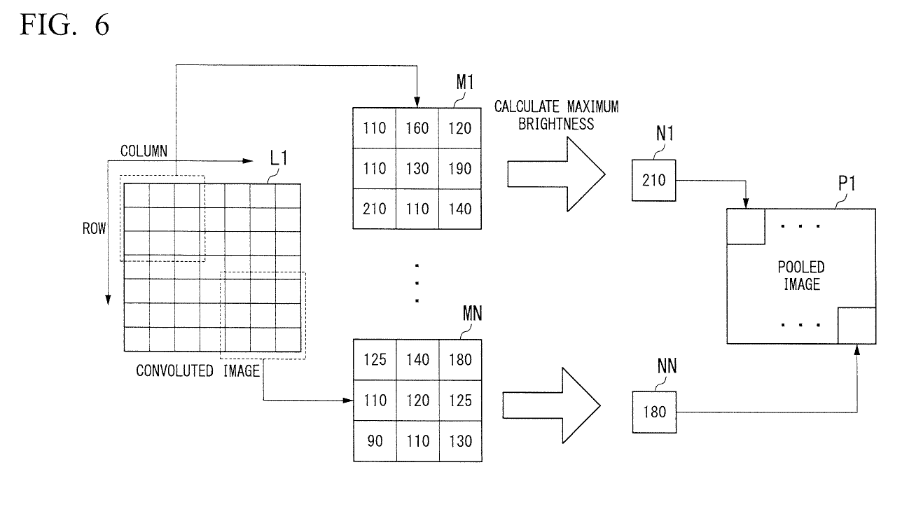

FIG. 6 is a diagram showing the pooling process of the first pooling processor 41 according to the present embodiment. For example, the first pooling processor 41 extracts an image of 3×3 pixels from the convoluted image L1 and calculates the maximum brightness and the average brightness of the image. FIG. 6 shows an example of calculating the maximum brightness. For example, the first pooling processor 41 extracts an image M1 of 3×3 pixels (of first to third rows×first to third columns) from the convoluted image L1 and acquires a single pixel N1 having the maximum brightness “210” from among the pixels. This pixel N1 constitutes an image of one pixel of the pooled image P1 (i.e., an image of the first row and the first column).

Then, the first pooling processor 41 slides the position of extraction from the convoluted image L1 by three pixels in the row direction (i.e., in the horizontal direction) and performs a similar pooling process. After completing the pooling process regarding the row direction, the first pooling processor 41 slides the extraction position by 3 pixels in the column direction (i.e., in the vertical direction) and performs a similar pooling process. In this manner, while moving the small image extraction position in the X direction and the Y direction, the first pooling processor 41 repeats the pooling process until the final position in the convoluted image L1 (for example, the lower right corner of the convoluted image L1) is reached. Although the extraction position is moved from the upper left corner to the lower right corner of the convoluted image L1 in the present embodiment, the order of movement is not limited to this, provided that it can move throughout the entire region of the convoluted image L1. A pooled image P1 is acquired through this pooling process.

The first feature image processor 32 generates a plurality of pooled images by performing a convolution process and a pooling process on the single first feature image F1 using different parameters (for example, parameters obtained by changing the size of the coefficient matrix, the coefficient values, the sliding interval, or the like) and inputs the pooled images into the sheet type identifier 35. In this case, various parameters of the pooling process may also be adjusted.

The convolution processes and the pooling processes of the first feature image processor 32, the second feature image processor 33, and the third feature image processor 34 are performed in parallel. That is, the first feature image processor 32, the second feature image processor 33, and the third feature image processor 34 perform, asynchronously with each other, respective convolution and pooling processes on the plurality of feature images extracted by the feature image extractor 31 (i.e., perform the processes on the feature images in parallel).

Then, the sheet type identifier 35 performs a full combination process on pooled images input from one of the first feature image processor 32, the second feature image processor 33, and the third feature image processor 34 (i.e., performs a full combination process on pooled images obtained from a single feature image) and performs a learning process for sheet type identification (step S111). For example, the sheet type identifier 35 first performs a full combination process on the pooled images obtained from the first feature image F1 input from the first feature image processor 32.

Then, the sheet type identifier 35 determines whether or not the full combination processes for all the feature images have been completed (step S113). For example, upon determining that the full combination processes for the second feature image F2 and the third feature image F3 have not been completed, the sheet type identifier 35 performs a full combination process on the second feature image F2 and performs a learning process for sheet type identification. On the other hand, upon determining that the full combination processes for all the feature images have been completed, the sheet type identifier 35 terminates the procedure of this flowchart.

That is, the sheet type identifier 35 sequentially performs a full combination process on the pooled images output from the first feature image processor 32, the second feature image processor 33, and the third feature image processor 34 (at different times). For example, the sheet type identifier 35 performs a full combination process on the pooled images input from the first feature image processor 32 at a certain time t, performs a full combination process on the pooled images input from the second feature image processor 33 at time t+1, and performs a full combination process on the pooled images input from the third feature image processor 34 at time t+2. The sheet type identifier 35 may repeatedly perform a full combination process on pooled images output from each of the first feature image processor 32, the second feature image processor 33, and the third feature image processor 34.

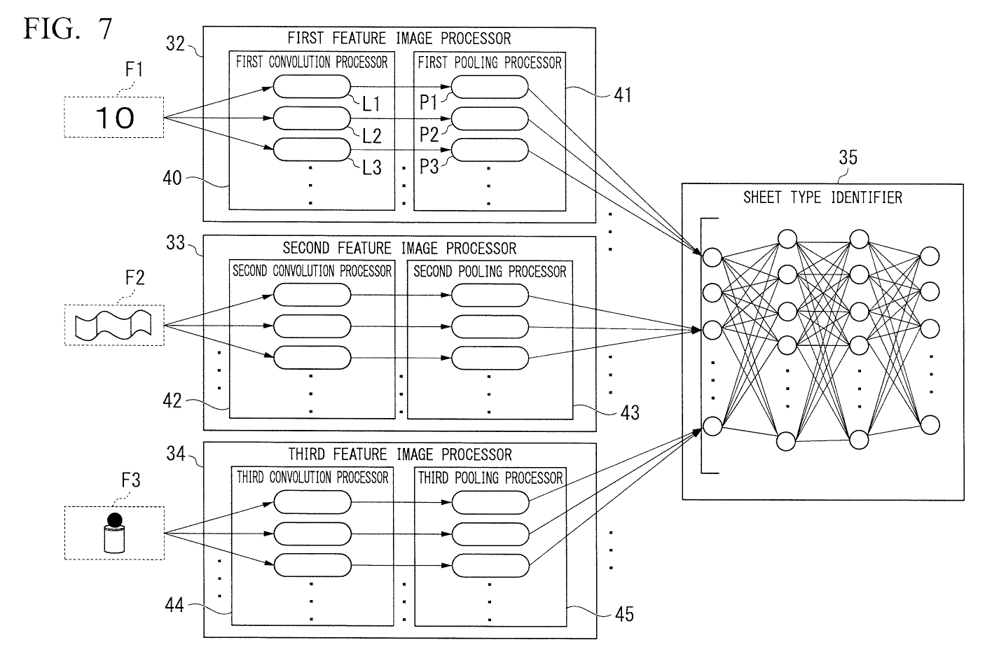

FIG. 7 is a diagram showing sheet type identification processes based on the first feature image F1, the second feature image F2, and the third feature image F3 in the sheet type identifier 35 according to the present embodiment. As shown in FIG. 7, a plurality of pooled images output from each of the first feature image processor 32, the second feature image processor 33, and the third feature image processor 34 are collected by the sheet type identifier 35 and are then subjected to the above-described full combination process. As a result, a learning process for various parameters (weight parameters) used in the full combination process is performed. A parameter set obtained as a result of the learning is applicable (i.e., common) to all of the first to third feature images F1, F2 and F3.

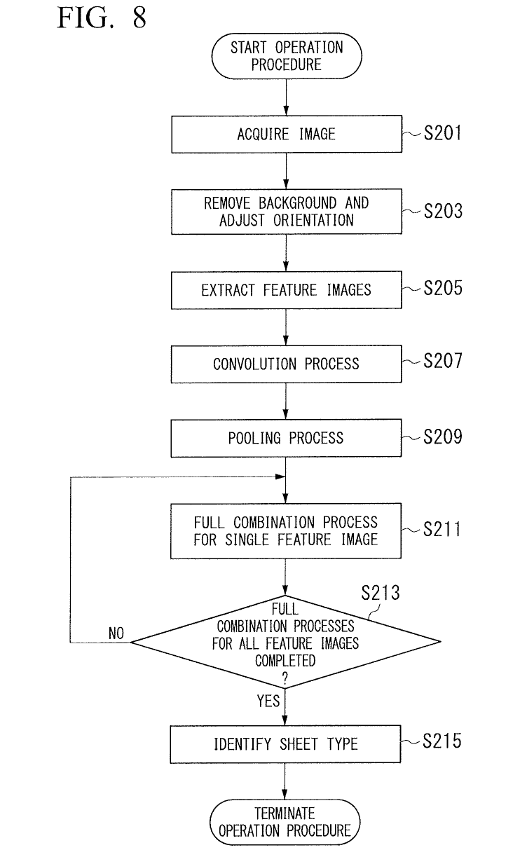

Now, a procedure in the operation stage will be described. FIG. 8 is a flowchart showing an example of a sequence of the procedure in the operation stage of the inspection device 16 according to the present embodiment.

First, the image acquirer 30 captures an image of a bill P passing through the inspection device 16 (a paper sheet identification device) and acquires the captured image (step S201). The image acquirer 30 inputs the acquired captured image into the feature image extractor 31.

Then, the feature image extractor 31 extracts a region where the image of the bill P has been captured (i.e., a bill image) from the entire captured image input from the image acquirer 30 and adjusts the orientation of the bill image in a predetermined direction (Step S203).

Then, the feature image extractor 31 extracts, from the bill image whose orientation has been adjusted in a predetermined direction, a plurality of small-scale characteristic images suitable for classifying the sheet type of the bill P on the basis of pre-specified coordinate information (step S205). For example, the feature image extractor 31 extracts, from the bill image 50 as shown in FIG. 3, the first feature image F1 which is an image of a region where a denomination numeral is printed, the second feature image F2 which is an image of a region where a symbol is printed, and the third feature image F3 which is an image of a region where a portrait image is printed. The feature image extractor 31 inputs the first feature image F1, the second feature image F2, and the third feature image F3 into the first feature image processor 32, the second feature image processor 33, and the third feature image processor 34, respectively.

Then, the first convolution processor 40 of the first feature image processor 32 performs a convolution process on the first feature image F1 input from the feature image extractor 31, the second convolution processor 42 of the second feature image processor 33 performs a convolution process on the second feature image F2, and the third convolution processor 44 of the third feature image processor 34 performs a convolution process on the third feature image F3 (Step S207).

Then, the first pooling processor 41 performs a pooling process on the convoluted image input from the first convolution processor 40, the second pooling processor 43 performs a pooling process on the convoluted image input from the second convolution processor 42, and the third pooling processor 45 performs a pooling process on the convoluted image input from the third convolution processor 44 (step S209).

Each of the first feature image processor 32, the second feature image processor 33, and the third feature image processor 34 generates a plurality of pooled images by performing a convolution process and a pooling process on the single first feature image F1 using different parameters (for example, parameters obtained by changing the size of the coefficient matrix, the coefficient values, the sliding interval, or the like) and inputs the pooled images into the sheet type identifier 35. The convolution processes and the pooling processes of the first feature image processor 32, the second feature image processor 33, and the third feature image processor 34 are performed in parallel.

Then, the sheet type identifier 35 performs a full combination process on pooled images input from one of the first feature image processor 32, the second feature image processor 33, and the third feature image processor 34 (i.e., performs a full combination process on pooled images obtained from a single feature image) (step S211). For example, the sheet type identifier 35 first performs a full combination process on the pooled images obtained from the first feature image F1 input from the first feature image processor 32.

Then, the sheet type identifier 35 determines whether or not the full combination processes for all the feature images have been completed (step S213). For example, upon determining that the full combination processes for the second feature image F2 and the third feature image F3 have not been completed, the sheet type identifier 35 performs a full combination process on the second feature image F2. The sheet type identifier 35 may repeatedly perform a full combination process on the pooled images output from each of the first feature image processor 32, the second feature image processor 33, and the third feature image processor 34.

On the other hand, upon determining that the full combination processes for all the feature images have been completed, the sheet type identifier 35 performs a sheet type identification process for the bill P on the basis of a result of the full combination process on the pooled images input from the first feature image processor 32, a result of the full combination process on the pooled images input from the second feature image processor 33, and a result of the full combination process on the pooled images input from the third feature image processor 34 (step S215) and displays the identification result on a display device (not shown) or the like. The procedure of this flowchart is then terminated.

According to the present embodiment described above, it is possible to provide a learning device, a paper sheet identification device, and a paper sheet identification method which enable highly accurate identification of the sheet type of a paper sheet in a short time. Further, in the present embodiment, it is possible to improve the accuracy of sheet type identification by extracting a plurality of feature images showing differences in design in a paper sheet and performing sheet type identification based on the plurality of feature images.

Further, in the present embodiment, the sheet type identifier 35 changes the pooled images to be subjected to the full combination process according to the time. Therefore, it is possible to apply a CNN, which is a deep learning technique, to a plurality of images without increasing a processing time. In addition, since a common full combination process is performed for a plurality of feature images, as compared to the case where a plurality of feature images are individually detected through a CNN and a comprehensive determination is then made, a comprehensive determination is unnecessary and the number of full combination processes is not increased and therefore it is possible to suppress an increase in calculation time. Further, it is possible to perform highly accurate sheet type identification by applying, through a learning method such as a hack-propagation method, transformation formulas which allow representative sheet type images to be detected most accurately through a convolution process and a pooling process.

In the present embodiment, the paper sheet P is not limited to a bill and may be a paper sheet having a printed pattern thereon. For example, the paper sheet P may be a postage stamp, a check, various forms, or the like. The representative images of the paper sheet P are not limited to denomination numerals, symbols, portraits and may be, for example, a stamp, a pattern on the reverse side of a bill, or the like.

According to at least one of the embodiments described above, the learning device 16 has an image acquirer 30, a feature image extractor 31, a plurality of image processors 32 to 34, and a sheet type identifier 35. The image acquirer 30 acquires a paper sheet image which is a captured image of a paper sheet. The feature image extractor 31 extracts a plurality of primary feature images having different objects to be recognized from the paper sheet image acquired by the image acquirer 30. The plurality of image processors 32 to 34 perform respective convolution and pooling processes on the plurality of primary feature images extracted by the feature image extractor 31 to generate a plurality of secondary feature images having different objects to be recognized. On the basis of the result of a combination process on each of the plurality of secondary feature images generated by the plurality of image processors 32 to 34, the sheet type identifier 35 sequentially updates and learns a parameter set for identifying the sheet type of the paper sheet. This allows the learning device according to the embodiments to highly accurately identify the sheet type of the bill P in a short time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning device comprising:
an acquirer configured to acquire a paper sheet image which is a captured image of a paper sheet;
an extractor configured to extract a plurality of primary feature images having different objects to be recognized from the paper sheet image acquired by the acquirer;
a plurality of processors configured to perform respective convolution and pooling processes on the plurality of primary feature images extracted by the extractor to generate a plurality of secondary feature images having different objects to be recognized; and
an identifier configured to sequentially update and learn a parameter set for identifying a sheet type of the paper sheet on the basis of a result of a combination process on each of the plurality of secondary feature images generated by the plurality of processors.

2. The learning device according to claim 1, wherein the identifier is configured to change the secondary feature images to be learned according to time.

3. The learning device according to claim 1, wherein the plurality of processors are configured to perform, asynchronously with each other, respective convolution and pooling processes on the plurality of primary feature images extracted by the extractor.

4. The learning device according to claim 1, wherein the plurality of processors are configured to perform respective convolution processes on the plurality of primary feature images to generate a plurality of convoluted images, and perform respective pooling processes on the plurality of convoluted images.

5. The learning device according to claim 1, wherein the identifier is configured to sequentially perform the combination processes on the plurality of secondary feature images generated by the plurality of processors.

6. A paper sheet identification device comprising:
an acquirer configured to acquire a paper sheet image which is a captured image of a paper sheet;
an extractor configured to extract a plurality of primary feature images having different objects to be recognized from the paper sheet image acquired by the acquirer;
a plurality of processors configured to perform respective convolution and pooling processes on the plurality of primary feature images extracted by the extractor to generate a plurality of secondary feature images having different objects to be recognized; and
an identifier configured to identify a sheet type of the paper sheet on the basis of a result of a combination process performed on each of the plurality of secondary feature images generated by the plurality of processors using a common parameter set for the plurality of secondary feature images.

7. The paper sheet identification device according to claim 6, wherein the identifier is configured to change the secondary feature images to be subjected to the combination process according to time.

8. The paper sheet identification device according to claim 6, wherein the plurality of processors are configured to perform, asynchronously with each other, respective convolution and pooling processes on the plurality of primary feature images extracted by the extractor.

9. The paper sheet identification device according to claim 6, wherein the plurality of processors are configured to perform respective convolution processes on the plurality of primary feature images to generate a plurality of convoluted images, and perform respective pooling processes on the plurality of convoluted images.

10. The paper sheet identification device according to claim 6, wherein the identifier is configured to sequentially perform the combination processes on the plurality of secondary feature images generated by the plurality of processors.

11. A sheet type identification method comprising:
acquiring a paper sheet image which is a captured image of a paper sheet;
extracting a plurality of primary feature images having different objects to be recognized from the paper sheet image;
performing respective convolution and pooling processes on the plurality of primary feature images to generate a plurality of secondary feature images having different objects to be recognized; and
identifying a sheet type of the paper sheet on the basis of a result of a combination process performed on each of the plurality of secondary feature images using a common parameter set for the plurality of secondary feature images.

12. The sheet type identification method according to claim 11, wherein the secondary feature images to be subjected to the combination process are changed with each other according to time.

13. The sheet type identification method according to claim 11, wherein the convolution and pooling processes on the plurality of primary feature images extracted are performed asynchronously with each other.

14. The sheet type identification method according to claim 11, wherein performing respective convolution and pooling processes includes performing respective convolution processes on the plurality of primary feature images to generate a plurality of convoluted images, and performing respective pooling processes on the plurality of convoluted images.

15. The sheet type identification method according to claim 11, wherein the combination processes on the plurality of secondary feature images are sequentially performs.
